(19) United States
(12) Patent Application Publication
(10) Pub. No.: US 2025/0229480 A1
(43) Pub. Date: Jul. 17, 2025

(54) SYSTEM FOR FITTING TOGETHER TWO PARTS WITH CHECKING SYSTEM

(71) Applicant: ERMO, Marcille-La-Ville (FR)

(72) Inventors: Bertrand LASCOUP, Marcille-La-Ville (FR); Maurizio DEL NEVO, Marcille-La-Ville (FR)

(73) Assignee: ERMO, Marcille-La-Ville (FR)

(21) Appl. No.: 19/013,934

(22) Filed: Jan. 8, 2025

(30) Foreign Application Priority Data
Jan. 16, 2024 (FR) 2400406

(51) Int. Cl. B29C 53/02; B29L 31/56; B65D 47/08; G01L 1/22

(52) U.S. Cl. CPC B29C 53/02; B65D 47/0838; G01L 1/2262; B29L 2031/565

(57) ABSTRACT

A fitting-together system for fitting together two parts and includes a thumbwheel having an axis of revolution and coming into abutment on the second part to fitted on the first part, two lever arms able to rotate about a rotation axis offset with respect to said axis of revolution, at least one force sensor secured to an element of the fitting-together system and arranged to emit an electrical value proportional to the deformation suffered when said thumbwheel rests on the second part, and a control unit connected to said at least one force sensor and arranged to compare the electrical value with a predefined interval of values.

### TECHNICAL FIELD

The present invention relates to a system for fitting together two parts comprising a system for checking that said two parts are correctly fitted together, as well as a moulding machine comprising such a fitting-together system.

### PRIOR ART

A closure of the type consisting of a closure for a bottle containing a liquid product such as shampoo, conditioner, washing-up product or the like, generally comprises a body and a cap. The body is intended to be fitted on the bottle and the cap is intended to be manoeuvred from a closed position to an open position and vice versa to enable the product to be held in the bottle or to flow out of the bottle.

Such closures can also be used in other sectors such as for example the automobile sector or in the medical field.

The body and the cap are moulded together and are connected to each other by a hinge that makes it possible to move the cap with respect to the body.

FIG. 1 shows two closures 50, where each comprises a body 50a and a cap 50b hinged on the body 50a.

Conventionally, the body 50a and the cap 50b are moulded in a moulding machine between two jaws that have recesses and reliefs and which come against each other to form cavities, where the body 50a and the cap 50b will be moulded.

FIG. 1 shows one of the jaws 60 on which the bodies 50a are held.

FIG. 1 also shows a fitting-together system 100 of the prior art that provides the tilting of each closure 50b and the fitting thereof on the associated body 50a.

The fitting-together system 100 comprises two parallel guide rails 102 and, for each guide rail 102, a carriage 104 able to move in translation on the guide rail 102.

For each carriage 104, the fitting-together system 100 comprises a first drive means 106, typically a motor with a ball screw, which provides the translational movement of the carriage 104 along the guide rail 102. The two carriages 104 are facing each other and move in a synchronised manner.

Each carriage 104 carries a lever arm 108, here in the form of a wheel, which is mounted so as to be able to rotate on the carriage 104 about a rotation axis 112. The axes of the lever arms 108 of the two carriages 104 are coaxial and, for each carriage 104, the fitting-together system 100 comprises a second drive means 114, typically a motor, which provides the rotational movement of the lever arm 108 of the carriage 104.

The fitting-together system 100 also comprises a fitting-together bar 110 that is mounted between the two wheels 108 and so as to be offset with respect to the rotation axis 112.

The operation of the fitting-together system 100 is then as follows. After moulding, the closures 50 are presented between the rails 102, and still secured here on the jaw 60. The carriages 104 are moved in translation along the rails 102 so as to bring the fitting-together bar 110 under the caps 50b. The lever arms 108 are rotated so as to pivot the caps 50b under the action of the fitting-together bar 110 and, at the same time, the carriages 104 are moved in translation along the rails 102 so that the fitting-together bar 110 rests on each cap 50b to fit it on the associated body 50a.

Although such a fitting-together system gives good results, it does not make it possible to check that the cap is correctly fitted on the body.

### DISCLOSURE OF THE INVENTION

One object of the present invention is to propose a fitting-together system that makes it possible to ensure that the fitting of the cap on the body has been perfectly implemented.

For this purpose, a fitting-together system is proposed, intended to fit a first part on a second part, said fitting-together system comprising:
a thumbwheel having an axis of revolution and intended to come into abutment on the second part to fit it on the first part,
two lever arms mounted so as to be able to rotate about a rotation axis parallel to said axis of revolution and offset with respect to said axis of revolution, wherein said thumbwheel is mounted so as to be able to rotate between the two lever arms about said axis of revolution.
at least one force sensor secured to an element of the fitting-together system and arranged to emit an electrical value proportional to the deformation suffered when said at least one thumbwheel rests on the second part, and
a checking unit connected to said at least one force sensor and arranged to compare the electrical value with a predefined interval of values.

According to one particular embodiment, the fitting-together system comprises:
a support shaft mounted between the two lever arms, and
a pair of bearings disposed on either side of the thumbwheel, wherein each bearing has a proximal cylinder and a distal cylinder both coaxial with the axis of revolution and connected to each other by at least one beam, wherein the distal cylinder is fitted fixedly on the support shaft, wherein the proximal cylinder is fitted freely on the support shaft and wherein the thumbwheel is fitted so as to be free to rotate on the proximal cylinder about said axis of revolution, and
wherein said at least one force sensor is secured to at least one of the beams and arranged to emit an electrical value proportional to the deformation of said at least one beam when the thumbwheel rests on the second part.

Advantageously, each force sensor is secured to a beam at a zone of said beam that has a reduced thickness.

According to a particular embodiment, said at least one force sensor is secured to at least one of the two lever arms and arranged to emit an electrical value proportional to the deformation of said at least one of the two lever arms when the thumbwheel rests on the second part.

Advantageously, each force sensor is secured to a lever arm at a zone of said lever arm that has a reduced thickness.

The invention also proposes a moulding machine comprising moulding means for moulding a first part and a second part and a fitting-together system according to one of the preceding variants.

### BRIEF DESCRIPTION OF THE DRAWINGS

The features of the invention mentioned above, as well as others, will emerge more clearly from the reading of the following description of an example embodiment, said description being made in relation to the accompanying drawings, among which:

FIG. 1 is a perspective view of a fitting-together system of the prior art,

FIG. 2 is a perspective view of a fitting-together system according to a first embodiment of the invention,

FIG. 3 is a perspective view of a fitting-together system according to a second embodiment of the invention,

FIG. 4 is a perspective view of a fitting-together system according to a third embodiment of the invention,

FIG. 5A is an exploded perspective view of a portion of the fitting-together system of FIG. 2,

FIG. 5B shows a perspective view of a bearing used in the fitting-together system of FIG. 2,

FIG. 6 is a perspective view of a portion of the fitting-together system of FIG. 3, and

FIG. 7 is a perspective view of a portion of the fitting-together system of FIG. 4.

### DETAILED DISCLOSURE OF EMBODIMENTS

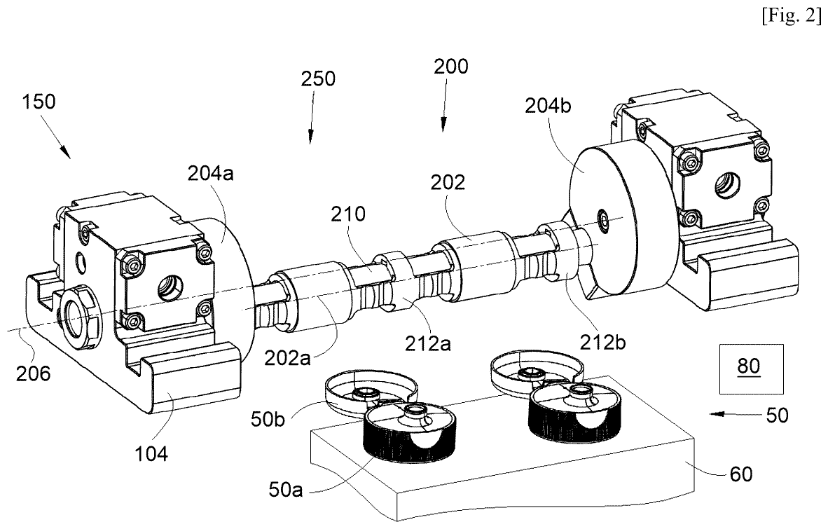

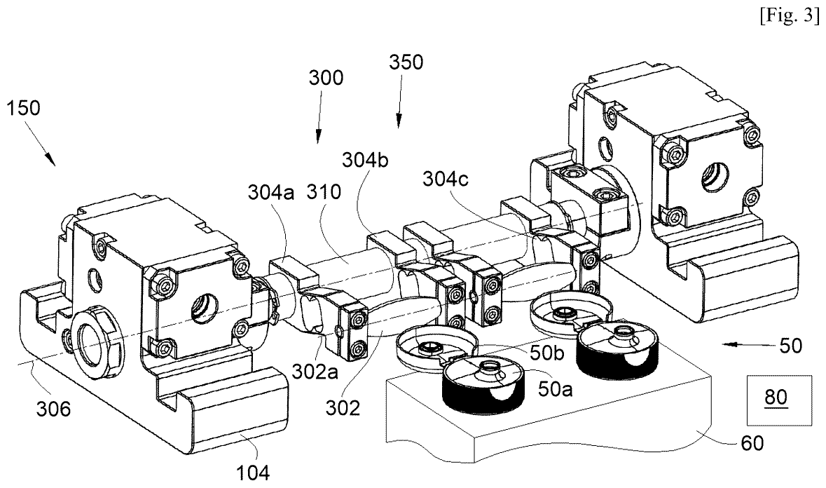

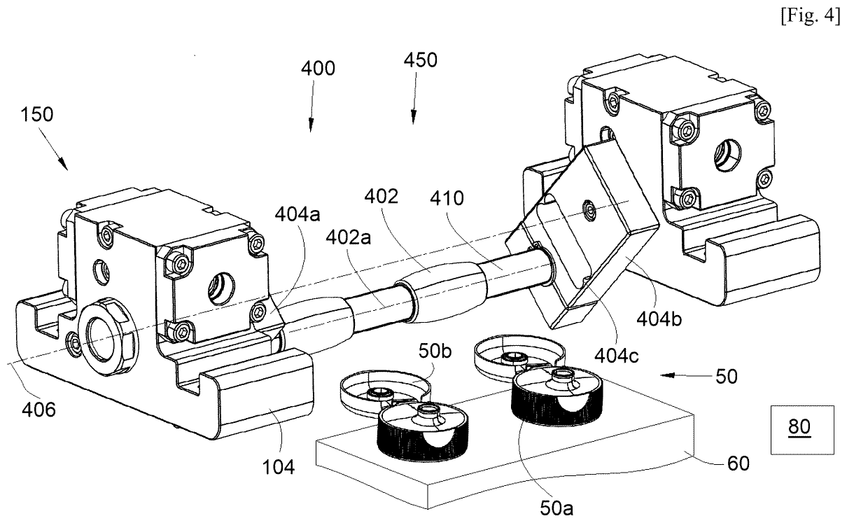

FIG. 2 shows a fitting-together system 200 according to a first embodiment of the invention, FIG. 3 shows a fitting-together system 300 according to a second embodiment of the invention and FIG. 4 shows a fitting-together system 400 according to a third embodiment of the invention.

Each fitting-together system 200, 300, 400 can be used in a moulding machine 150 that comprises moulding means including at least one jaw 60.

The moulding means conventionally comprise jaws 60 that are conformed to implement the moulding of a first part 50a and of a second part 50b secured to each other by a hinge moulded at the same time as the parts 50a and 50b. In the embodiment of the invention presented here, the first part 50a is a body 50a of a closure 50 and the second part 50b is a cap 50b of the same closure 50 hinged on the body 50a.

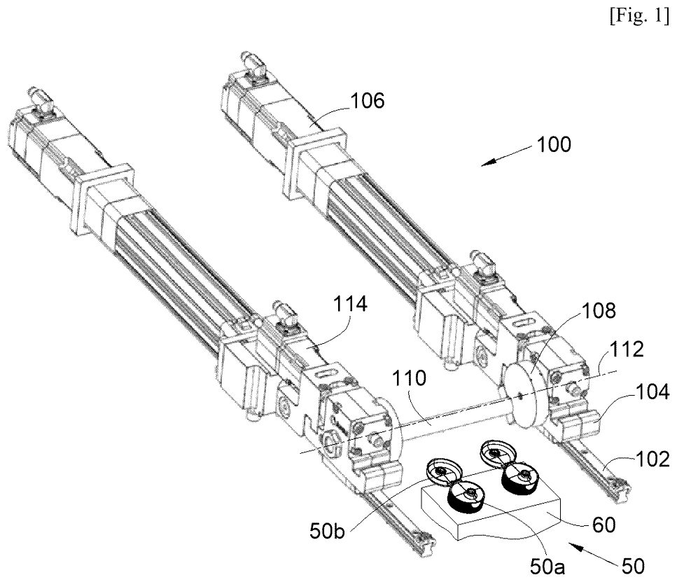

Each fitting-together system 200, 300, 400 can take a form similar to that of the fitting-together system 100 of the prior art described from FIG. 1.

The fitting together system 200, 300, 400 thus comprises two carriages 104 between which the fitting-together module 250, 350, 450 is mounted. As with the prior art, the carriages 104 are mounted movably so that the fitting-together module 250, 350, 450 moves and fits the first part 50a on the second part 50b.

For example, the fitting-together system 200, 300, 400 comprises two parallel guide rails along each of which a carriage 104 is mounted so as to be able to move in translation through the action of a first drive means, such as a motor with a ball screw. The two carriages 104 are facing each other and move in a synchronised manner.

The fitting-together module 250, 350, 450 comprises at least one thumbwheel 202, 302, 402 having an axis of revolution 202a, 302a, 402a and intended to move the second part 50b and to come into abutment on the second part 50b to fit it on the first part 50a. In the remainder of the description, mention is made of a single thumbwheel 202, 302, 402, but it can apply to a plurality of thumbwheels 202, 302, 402 that are aligned along the axis of revolution 202a, 302a, 402a.

The fitting-together module 250, 350, 450 comprises at least two lever arms 204a-b, 304a-b, 404a-b that are mounted so as to be able to rotate about a rotation axis 206, 306, 406 that is parallel to the axis of revolution 202a, 302a, 402a and offset with respect to the latter. For one and the same fitting-together module 250, 350, 450, the rotation axes 206, 306, 406 of all the lever arms 204a-b, 304a-b, 404a-b are coaxial.

In each embodiment, the or each thumbwheel 202, 302, 402 is mounted so as to be able to rotate between the two lever arms 204a-b, 304a-b, 404a-b about the axis of revolution 202a, 302a, 402a.

In the embodiment of the invention presented in FIG. 2, there are two lever arms 204a-b and between them there are a plurality of thumbwheels 202.

In the embodiment of the invention presented in FIG. 3, there are two pairs of lever arms 304a-b and there is a thumbwheel 302 between two lever arms 304a-b of one and the same pair.

In the embodiment of the invention presented in FIG. 4, there are two lever arms 404a-b and between them there are a plurality of thumbwheels 402.

The lever arms 204a-b, 304a-b, 404a-b are mounted so as to be able to rotate between the carriages 104 wherein for this purpose at least one is equipped with a second drive means, such as a motor, which rotates the lever arms 204a-b, 304a-b, 404a-b about the rotation axis 206, 306, 406 to bring the thumbwheel 202, 302, 402 under the second part 50b, to pivot the latter and to fit it on the first part 50a.

In the embodiment of the invention presented in FIG. 2, each lever arm 204a-b takes the form of a wheel coaxial with the rotation axis 206, and the thumbwheels 202 are fitted so as to be able to rotate freely on a support shaft 210. The support shaft 210 is mounted fixedly on the two lever arms 204a-b coaxially with the axis of revolution 202a. Each wheel is then rotated by a second drive means.

In the embodiment of the invention presented in FIG. 3, each lever arm 304a-b takes the form of a beam a proximal end of which is mounted fixedly on a rotation shaft 310 mounted between the two carriages 104 coaxially with the rotation axis 306 and a distal end of which carries the thumbwheel 302. Each thumbwheel 302 is thus mounted between two distal ends of two lever arms 304a-b. The rotation shaft 310 is then rotated by a second drive means.

In the embodiment of the invention presented in FIG. 4, there are two lever arms 404a-b and each takes the form of a beam a proximal end of which is mounted so as to be able to rotate on a carriage 104 coaxially with the rotation axis 406 and a distal end of which carries a support shaft 410 coaxial with the axis of revolution 202a and which carries the or each thumbwheel 402. Each proximal end is then rotated by a second drive means.

The fitting-together module 250, 350, 450 also comprises at least one force sensor 208, 308, 408, typically a deformation gauge operated by a Wheatstone bridge, secured to an element of the fitting-together system 200, 300, 400, and more specifically of the fitting-together module 250, 350, 450, and arranged to measure the deformation of the element when a thumbwheel 202, 302, 402 bears on the second part 50b. Thus, when a thumbwheel 202, 302, 402 rests on the second part 50b, the force thus generated is transferred to the carriage 104 and, by positioning at least one force sensor 208, 308, 408 along this transfer path, this force sensor 208, 308, 408 deforms and the deformation thereof is proportional to the force exerted on the second part 50b.

Each sensor 208, 308, 408 emits an electrical value proportional to the deformation suffered when a thumbwheel 202, 302, 402 bears on the second part 50b and, by collecting each electrical value over several fitting-together cycles, a control unit 80 can know whether the fittings together always take place correctly or not. In the latter case, an adjustment of the fitting-together system 200, 300, 400 may be necessary.

The electrical values are collected by the control unit 80 connected to each force sensor 208, 308, 408.

The control unit 80 is thus arranged to record the electrical values received from each force sensor 208, 308, 408 and to compare these electrical values with a predefined interval of values corresponding to a correct fitting together of the two parts 50a-b.

The control unit 80 can also be arranged to send an alert signal in the case of the detection of a problem, i.e. when an electrical value is outside the predefined interval of values.

With such an arrangement, it is easy to automatically monitor that the fittings together take place correctly.

As described above, in the embodiment in FIG. 2, the fitting-together system 200 comprises the support shaft 210 mounted between the two lever arms 204a-b and is secured to each of them. The fitting-together system 200 also comprises, for each thumbwheel 202, a pair of bearings 212a-b, where the bearings 212a-b are disposed on either side of the thumbwheel 202. Each thumbwheel 202 and each bearing 212a-b are fitted on the support shaft 210.

In the case of FIG. 2, there are two thumbwheels 202, one double bearing 212a and two single bearings 212b. The double bearing 212a is disposed between the two thumbwheels 202 and cooperates with each of them, and each single bearing 212b cooperates with a single thumbwheel 202. Naturally, depending on the number of thumbwheels 202, the number of bearings 212a-b varies. In the same way, the double bearing 212a can be replaced by two single bearings.

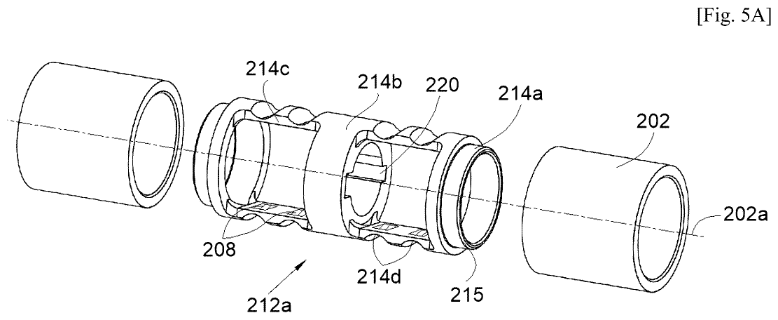

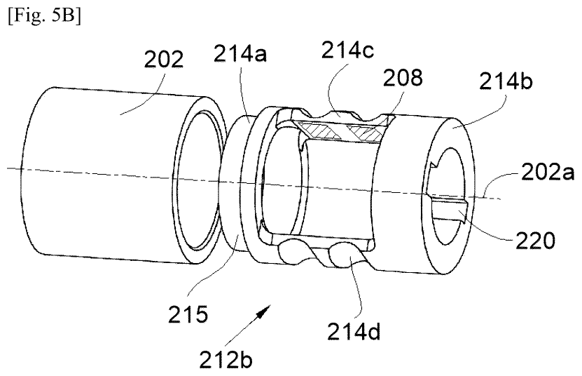

FIG. 5A shows the double bearing 212a, and FIG. 5B shows a single bearing 212b.

Each bearing 212a-b has a proximal cylinder 214a and a distal cylinder 214b, in the case of the double bearing 212a there are two proximal cylinders 214a on either side of the distal cylinder 214b, which is here at the middle.

The cylinders 214a-b are coaxial with the axis of revolution 202a and are connected to each other by at least one beam 214c, here two. Each beam 214c is roughly parallel to the axis of revolution 202a.

The distal cylinder 214b is fitted fixedly on the support shaft 210, i.e. the fit is sufficiently tight for the forces that the distal cylinder 214b is subjected to are transmitted to the support shaft 210. In the embodiment of the invention presented here, the connection between the distal cylinder 214b and the support shaft 210 is supplemented by keys slid in the grooves 220 of the distal cylinder 214b and of the support shaft 210 to prevent the rotation of one with respect to the other.

The proximal cylinder 214a is fitted freely on the support shaft 210, i.e. the fit is sufficiently slack for the forces that the proximal cylinder 214a is subjected to during a fitting together are not transmitted to the support shaft 210, there is thus always a space between them.

The thumbwheel 202 is fitted so as to be able to rotate freely on the proximal cylinder 214a about the axis of revolution 202a. As with the proximal cylinder 214a, the thumbwheel 202 is always at a distance from the support shaft 210.

Here are the proximal cylinder 214a has a barrel 215 the outside diameter of which is less than the inside diameter of the thumbwheel 202, and the latter is fitted on this barrel 215. The thumbwheel 202 is thus fitted at each end on a barrel 215. The inside diameter of the barrel 215 is sufficiently great to avoid contacts with the support shaft 210 during a fitting together.

In the embodiment of the invention presented here, the force sensors 208, here two in number, are secured to at least one of the beams 214c.

In the embodiment presented here, there are two force sensors 208, on one beam 214c, but there may be at least one of them, and each beam 214c may be equipped therewith. The greater the number of force sensors 208, the greater the number of electrical values supplied and the better is the knowledge about the fitting together, but the more difficult the management of the electrical values becomes.

Each force sensor 208 is thus arranged to emit an electrical value proportional to the deformation of the beam 214c where it is secured, when the thumbwheel 202 rests on the second part 50b.

In the embodiment of the invention presented in FIG. 2, the beam 214c equipped with force sensors 208 constitutes the element of the fitting-together system 200 the deformation of which is monitored.

Thus, when the thumbwheel 202 rests on the second part 50b, the thumbwheel 202 moves radially with respect to the support shaft 210, which causes a similar movement of each proximal cylinder 214a on either side of the thumbwheel 202 and therefore a deformation of the corresponding beams 214c, which deforms the associated force sensors 208.

To increase the deformation of the force sensor 208, each is secured to a beam 214c at a zone 214d of the beam 214c that has a reduced thickness. For this purpose, the beam 214c is hollowed out at each force sensor 208.

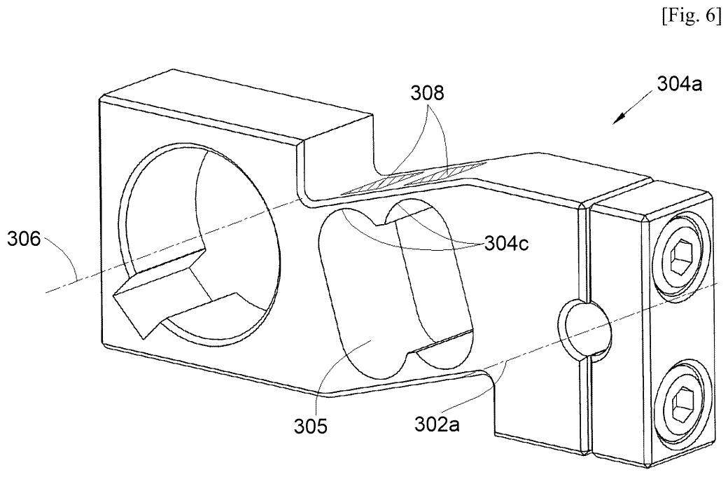

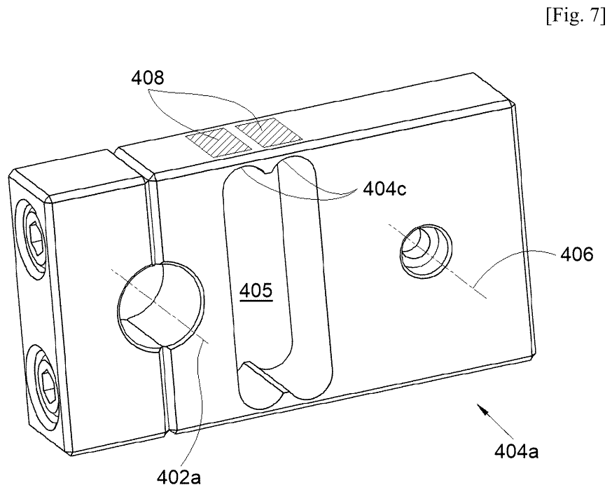

In the embodiments in FIGS. 3 and 4, the force sensors 308, 408 are secured to the two lever arms 304a-b, 404a-b, and FIGS. 6 and 7 show examples of these lever arms, 304a, 404a.

Each force sensor 308, 408 is thus arranged to emit an electrical value proportional to the deformation of the lever arm 304a-b, 404a-b when the thumbwheel 302, 402 rests on the second part 50b. As before, the number of force sensors 308, 408 can be adapted.

In these embodiments, the lever arms 304a-b, 404a-b equipped with force sensors 208 constitute the elements of the fitting-together system 300, 400 the deformation of which is monitored.

Thus, when the thumbwheel 302, 402 rests on the second part 50b, the thumbwheel 302, 402 forces on the lever arm 304a-b, 404a-b, which deforms it and causes a deformation of the associated force sensors 208.

To increase the deformation of the force sensor 308, 408, each is secured to a lever arm 304a-b, 404a-b at a zone 304c, 404c of the lever arm 304a-b, 404a-b that has a reduced thickness. Here the reduced thickness is obtained by producing a hollow 305, 405 passing through the lever arm 304a-b, 404a-b parallel to the axis of revolution 302a, 402 between the latter and the rotation axis 206, 306. The force sensor 308, 408 is secured to an edge of this hollow 305, 405. In general terms, the force sensors 208, 308, 408 are secured to surfaces (beams 214c, lever arms 304a-b, 404a-b) that are orthogonal to the force undergone so that they are folded over their thicknesses.

According to a particular embodiment, the control unit 80 comprises, connected by a communication bus: a processor or CPU (“central processing unit”) 401; a random access memory (RAM); a read only memory, for example of the ROM or EEPROM (electrically-erasable programmable ROM) type, or of the flash type;; a storage unit, such as a hard disk drive HDD, or a storage medium reader, such as an SD (Secure Digital) card reader 404; and an interface manager I/f.

The interface manager I/f enables the control unit 80 communicate with, among other things, the force sensors 208, 308, 408.

The processor is capable of executing instructions loaded in the random access memory from the read-only memory, from an external memory from a storage medium (such as an SD card), or from a communication network. When the hardware platform is powered up, the processor is capable of reading instructions from the random access memory and executing them. These instructions form a computer program causing the implementation, by the processor, of all or some of the steps and operations described here.

All or some of the steps and operations described here can thus be implemented in software form by executing a set of instructions by a programmable machine, for example a processor of the DSP (“digital signal processor”) type or a microcontroller, or be implemented in hardware form by a machine or a dedicated electronic component (chip) or a set of electronic components (chipset), for example an FPGA (field-programmable gate array) or ASIC (application-specific integrated circuit) component. In general terms, the control device 80 comprises electronic circuitry adapted and configured to implement the operations and steps described here.

1. A fitting-together system intended to fit a first part on a second part, said fitting-together system comprising:
a thumbwheel having an axis of revolution and intended to come into abutment on the second part to fit it on the first part,
two lever arms mounted so as to be able to rotate about a rotation axis parallel to said axis of revolution and offset with respect to said axis of revolution, wherein said thumbwheel is mounted so as to be able to rotate between the two lever arms about said axis of revolution,
at least one force sensor secured to an element of the fitting-together system and arranged to emit an electrical value proportional to the deformation suffered when said thumbwheel rests on the second part, and
a checking unit connected to said at least one force sensor and arranged to compare the electrical value with a predefined interval of values.

2. The fitting-together system according to claim 1, wherein it comprises:
a support shaft mounted between the two lever arms, and
a pair of bearings disposed on either side of the thumbwheel, wherein each bearing has a proximal cylinder and a distal cylinder both coaxial with the axis of revolution and connected to each other by at least one beam, wherein the distal cylinder is fitted fixedly on the support shaft, wherein the proximal cylinder is fitted freely on the support shaft and wherein the thumbwheel is fitted so as to be free to rotate on the proximal cylinder about said axis of revolution, and
wherein said at least one force sensor is secured to at least one of the beams and arranged to emit an electrical value proportional to the deformation of said at least one beam when the thumbwheel rests on the second part.

3. The fitting-together system according to claim 2, wherein each force sensor, each is secured to a beam at a zone of said beam that has a reduced thickness.

4. The fitting-together system according to claim 1, wherein said at least one force sensor is secured to at least one of the two lever arms and arranged to emit an electrical value proportional to the deformation of said at least one of the two lever arms when the thumbwheel rests on the second part.

5. The fitting-together system according to claim 4, wherein each force sensor is secured to a lever arm at a zone of said lever arm that has a reduced thickness.

6. A moulding machine comprising moulding means for moulding a first part and a second part and a fitting-together system according to claim 1.
